(19) United States
(12) Patent Application Publication
(10) Pub. No.: US 2015/0082655 A1
(43) Pub. Date: Mar. 26, 2015

(54) LED INK CURING APPARATUS

(71) Applicant: GEW (EC) Limited, West Sussex (GB)

(72) Inventors: Malcolm Rae, West Sussex (GB); Benjamin Tyler, West Sussex (GB); Robert Rae, West Sussex (GB)

(21) Appl. No.: 14/492,912

(22) Filed: Sep. 22, 2014

(30) Foreign Application Priority Data
Sep. 23, 2013 (GB) 1316826.5
Sep. 17, 2014 (GB) 1416477.6

(51) Int. Cl. B41F 23/04; F26B 23/06

(52) U.S. Cl. CPC B41F 23/0486; F26B 23/06
USPC 34/275

(57) ABSTRACT

An LED array (1) for UV print curing comprising one or more LED modules (2), the array (1) comprising a body (5) which comprises a mounting area (4) comprising one or more LED modules (2) mounted thereon, and two or more fixing holes (6) through the body (5), the position of said fixing holes (6) corresponding to the position of fixing holes (7) in the one or more LED modules (2) mounted on the mounting area (4), wherein the one or more LED modules (2) are secured to the body (5) by pins (8, 38) which pass through the fixing holes (7) within the LED module (2) and through the fixing holes (6) in the body (5), said pins (8, 38) comprising a head (9, 39) and a stem (10, 40), wherein the head (10, 40) engages with a conductive surface (11) on the LED module (2) and the stem (10, 40) is connectable to a power supply for providing power to the conductive surface (11) of the LED module (2) via the head (10, 40).

### CROSS-REFERENCE TO RELATED APPLICATIONS

This application claims priority to GB provisional application Serial No. 1316826.5, filed on Sep. 23, 2013 and GB provisional application Serial No. 1416477.6 filed on Sep. 17, 2014, the content of which is incorporated herein by reference in its entireties.

### BACKGROUND

The present invention relates to an LED array for use in a UV ink curing apparatus.

The use of ultra violet (UV) LED (light-emitting diode) arrays for ink curing is becoming increasingly popular as an alternative to traditional mercury arc UV lamps. However, the manufacture and use of UV LED arrays in ink curing systems suffers from many problems.

For example, the LED modules provided within the LED array are often difficult to replace in the event of failure. In addition, it can be difficult to correctly insert LED modules into an array so that they are in the correct orientation for curing and are securely fitted to maintain electrical connection during use.

The present invention sets out to provide an improved LED array, which alleviates the problems described above.

In one aspect, the invention provides an LED array for UV print curing comprising one or more LED modules, the array comprising

a body which comprises a mounting area comprising one or more LED modules mounted thereon, and

two or more fixing holes through the body, the position of said fixing holes corresponding to the position of fixing holes in the one or more LED modules mounted on the mounting area,

wherein the one or more LED modules are secured to the body by pins which pass through the fixing holes within the LED module and through the fixing holes in the body, said pins comprising a head and a stem, wherein the head engages with a conductive surface on the LED module and the stem is connectable to a power supply for providing power to the conductive surface of the LED module via the head.

By using a configuration having pins to secure the LED modules to the body a much improved LED array is achieved. The present invention allows for better control and consistency of the clamping force between the pin head and the LED module and avoids the risk of damage to the valuable LED modules. The pin configuration and fixing holes ensure that the LED modules are secured in the correct orientation and position and allows for reduced time, cost and skill to maintain the LED array of the present invention. Furthermore, the compact configuration of the present invention allows for the number of LED modules that can be mounted in an array to be maximised, whilst ensuring good electrical connection is achieved.

Preferably the LED array comprises a securing element for securing the pins such that the head of each pin is in contact with the conductive surface of the or each LED module.

Preferably, the securing element comprises a nut rotatable about a screw thread provided on the stem of the pin.

A nut and bolt arrangement allows for the or each LED module to be mounted without the use of complex tooling; for example, during maintenance of the LED array where the time and inconvenience of maintenance is much reduced. The configuration of the nut and bolt is pre-determined to ensure that the LED modules are correctly positioned and securely connected. The force needed to achieve the required electrical connection between the pin head and the LED module is known, so that on correct tightening of the nut to the threaded section of the pin stem proper electrical contact is achieved. A nut and bolt arrangement also reduces the overall part count of the LED array such that the array is more cost-effective to manufacture and requires less machining complexity.

Preferably, the pin head comprises a circular cross-section.

A circular cross-section allows the pin to be positioned in any orientation whilst enabling the pin to secure the LED modules to the body of the LED array.

Preferably, the pin head comprises a substantially planar contact surface.

By “substantially” it is understood that about 70% of the pin head surface lies in the same plane, more preferably about 80% of the pin head surface lies in the same plane, and even more preferably about 90% of the pin head surface lies in the same plane.

The upper, contact surface of the pin head is configured to ensure that the surface area making contact with the conductive surface of the LED module is maximised, so that electrical contact is optimal. A compact pin head design maximises the surface area for electrical contact. Good electrical connection can be achieved whilst allowing multiple LED modules to be secured close together. By allowing the LED modules to be secured close together, the present invention allows for a greater number of LED modules to be mounted in the LED array.

Preferably, each pin is made of brass and is, optionally, nickel plated.

Brass pins provide good electrical conducting properties, whilst nickel-plating stops oxidisation.

Preferably, the array comprises a biasing element for biasing the position of the head of each pin towards the conductive surface of the LED module when the pin is secured in place by a securing element.

Each LED module is connected to the body by two or more pins which secure the LED module to the body and to conduct electrical power from a power supply to the conductive surface of each LED module. The biasing element ensures that the contact between the head and the conductive surface is maintained during use and compensates for any potential loosening or movement of the pin and/or the securing element during the thermal cycling during print curing.

The arrangement of the present invention is also particularly advantageous during manufacture of the LED array. In this respect, no approximation is necessary when deciding how tight the securing element should be secured in order to achieve the required biasing effect. Rather, this is determined by the known configuration of the nut and bolt arrangement and/or the biasing element which provides a known, pre-determined, continuous force.

The LED modules can be individually replaced in the event of failure. This is particularly advantageous because it means that the array of the present invention can be repaired without replacement of a full array of LED modules. Thus, the “down-time”, and associated cost and inconvenience necessary for repair of the UV apparatus are much reduced. Furthermore, any safety risks occurring during repair of the array are also reduced.

Preferably, the end of each pin that is distal from the pin head is shaped for engagement with an electrical connector of a power supply.

The pins of the present invention allow for easy connection to a power supply, for example in a push-fit or click-fit arrangement. A “click-fit” arrangement will allow a user to gain a tactile indication of when the pin has been correctly inserted.

Preferably, a pair of fixing holes is provided for each LED module.

Preferably, the fixing holes in each of the LED modules are provided in an offset configuration.

Preferably, the fixing holes in each pair of fixing holes are provided in an offset configuration.

An offset configuration, wherein the position of the holes permits installation of the LED module in only one configuration, ensures that each LED module can only be mounted on the mounting area in a particularly desirable configuration, and ensuring that the LED modules cannot be installed incorrectly without the risk of human error.

Preferably, the array comprises electrically insulating components, such as electrically insulating sleeves, for preventing electrical contact between the stem of the or each pin and the LED module.

More preferably, the array comprises a tubular electrically insulating sleeve.

Preferably, each electrically insulating sleeve extends around the neck of each of the pins.

Preferably, the head of each pin comprises a recess for accommodating a neck portion of an electrical insulating sleeve positioned around the stem of the pin.

Preferably, the array comprises a plurality of LED modules placed adjacent to each other (side-by-side).

Preferably, the mounting area comprises a substantially flat recess within the body.

Preferably, the mounting area comprises a recess within a substrate-facing surface of the body.

Preferably, the body acts as a heat sink for heat generated by the LEDs.

Preferably, the body comprises a cooling element.

Preferably, the cooling element comprises a channel formed within the body through which a fluid, such as water or air, can pass.

Preferably, the channel is a flow and return channel.

Preferably, the entrance and exit of the channel are in the same surface of the body.

Preferably, the biasing element is selected from a spring; deformable gasket; or belleville washer.

More preferably, the biasing element comprises a spring.

Preferably, the biasing element is provided around the stem of the pin.

Preferably, the securing element comprises a retaining clip.

The use of a retaining clip is particularly advantageous because it allows for easy installation and removal of the LED modules. In addition, and with reference to the advantages of providing a biasing element, the use of a retaining clip removes the need for approximation during installation of the LED modules.

Preferably, the biasing element is housed within an electrical insulator.

Preferably, the electrical insulator is accommodated within a recess in the body.

Preferably, the end of each pin that is distal from the pin head is exposed on the opposite side of the electrical insulator to provide for connection to an electrical connector of a power supply.

Preferably, the array comprises a cover comprising an aperture through which light generated by the LEDs can pass.

Preferably, the cover comprises two cover parts, each part positioned over opposing ends of the LED modules with a gap formed between the cover parts forming the aperture.

Preferably, the cover parts comprise plates.

Preferably, the array comprises a transparent window for the aperture.

Preferably, the transparent window is removable.

Preferably, the transparent window is slideably removable from the array. This allows for easy removal, cleaning, or replacement of the transparent window without the need to dismantle or remove the array from an ink curing apparatus. This is particularly advantageous because it minimises any disruption in printing.

Preferably, the transparent window is a quartz window, preferably a synthetic quartz window.

Preferably, opposing edges of the cover which define the aperture comprise recesses for slideably accommodating the transparent window.

Preferably, the cover passes over the head of each pin.

Preferably, the head of each pin is electrically insulated from the cover.

Preferably, the head of each of the pins is accommodated within a respective recess on the module facing surface of the cover.

Preferably, a heat conducting material is provided between the one or more LED modules and the body. This draws heat away from the LED modules and into the body, thus cooling the LED modules.

Preferably, a heat conducting material is provided between the one or more LED modules and the cover. This draws heat away from the substrate-facing surface of the LED modules into the cover and then into the body to which the cover is attached.

In embodiments wherein a heat conducting material is provided between (i) the one or more LED modules and the body and, (ii) the one or more LED modules and the cover, heat is drawn away from both surfaces of the LED modules. This arrangement is particularly effective at cooling the LED modules.

The efficient cooling arrangement of the present invention ensures that the array can be operated with a minimal thermal footprint.

Preferably, the array comprises an outer casing.

Preferably, the LED array is a UV LED array.

According to another aspect of the present invention, there is provided a UV ink curing apparatus comprising one or more LED arrays of the present invention.

Preferably, the ink curing apparatus comprises a “kissing roller”, that is, a roller for passing a substrate in close proximity to the one or more LED modules. This ensures that the substrate passes as close as possible to the LED array and, in turn, the LEDs mounted on the LED modules, without any wrinkling of the web upon which the substrate is placed. In addition, the arrangement of the arrays of the present invention ensures that the maximum possible dose and intensity of UV light reaches the substrate in an efficient way.

For the purposes of clarity and a concise description, features are described herein as part of the same or separate embodiments; however it will be appreciated that the scope of the invention may include embodiments having combinations of all or some of the features described.

The invention will now be described by way of example with reference to the accompanying drawings, in which:—

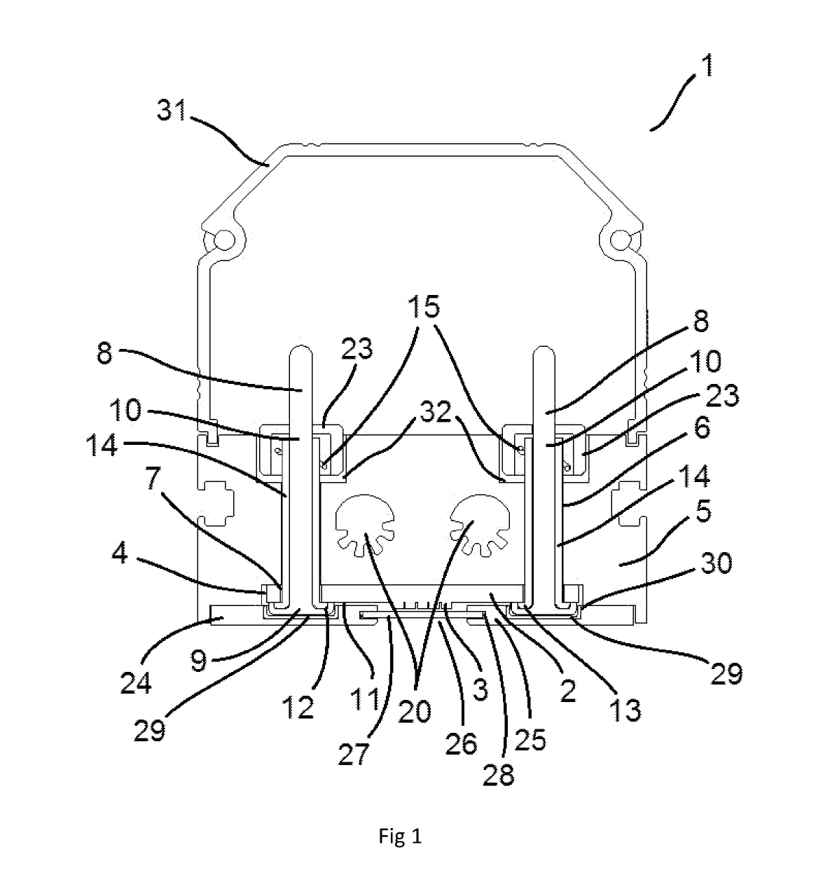

FIG. 1 is a cross-sectional view through an array constructed according to the present invention;

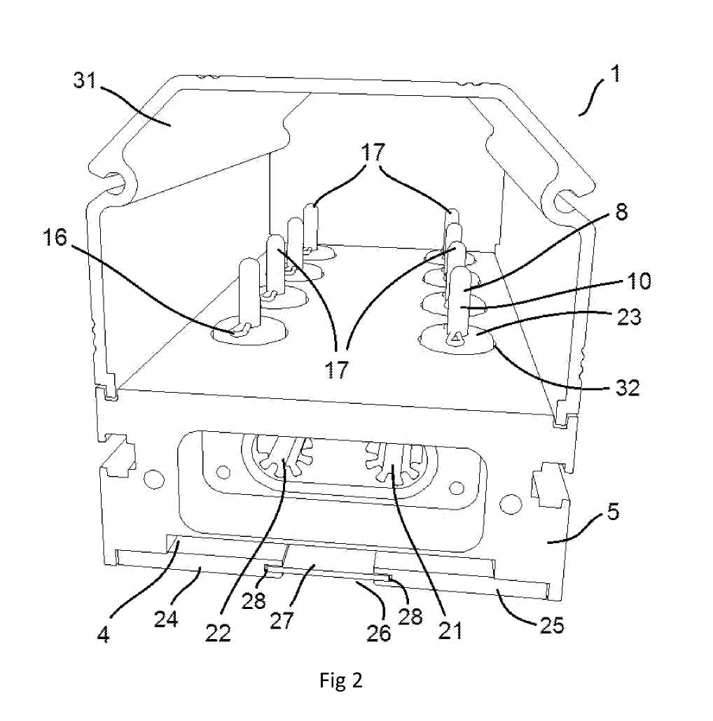

FIG. 2 shows a perspective view along an array constructed according to the present invention;

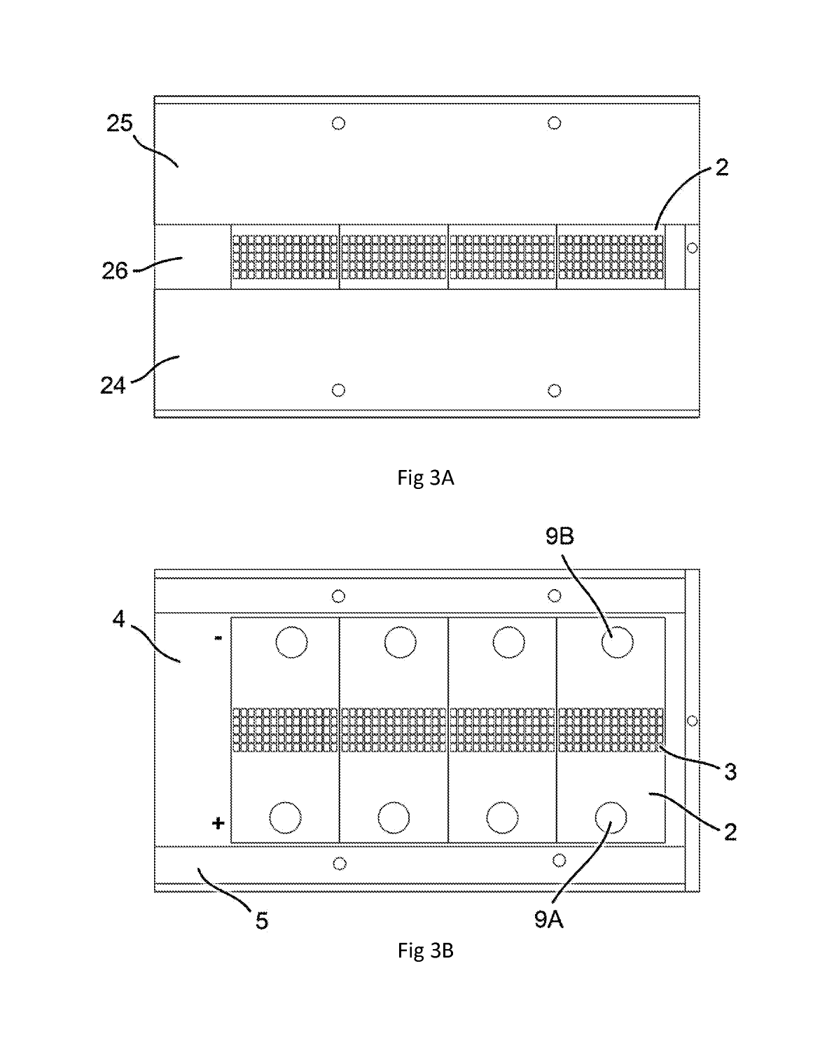

FIG. 3 shows a view of a substrate facing side of an array according to the present invention with (FIG. 3A) and without (FIG. 3B) cover plates;

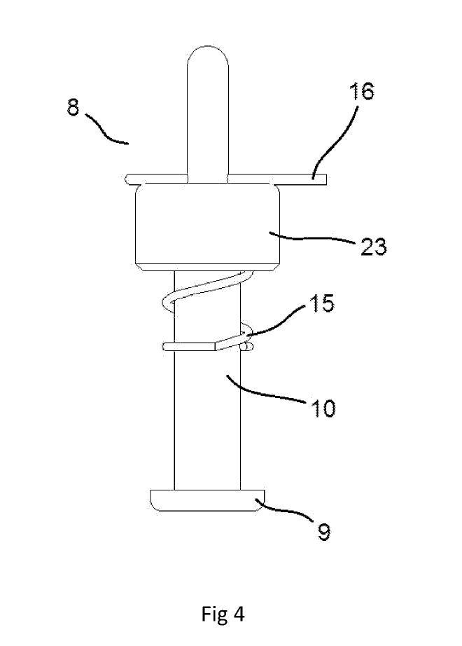

FIG. 4 shows a pin for use in an array according to the present invention; and

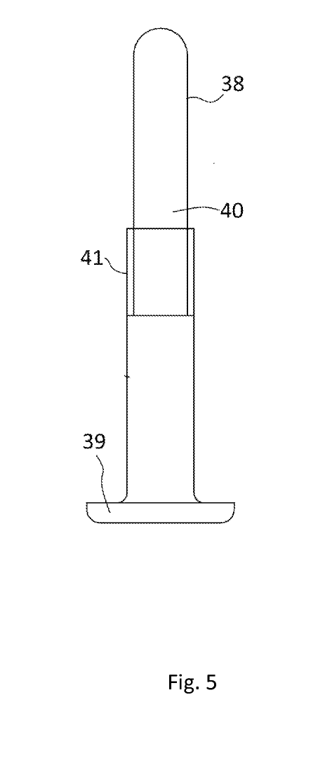

FIG. 5 shows a second embodiment of the pin for use in an array according to the present invention.

The present invention relates to an LED array for use in a UV curing system.

Within this specification, the term “LED module” means a unit containing one or more LEDs that is supplied as a light source.

Within this specification, the term “about” means plus or minus 20%, more preferably plus or minus 10%, even more preferably plus or minus 5%, most preferably plus or minus 2%.

Referring to FIG. 1 there is shown an LED array 1 comprising a plurality of LED modules 2. Each module comprises a plurality of LEDs 3. A mounting area 4, in the form of a recess, is provided within a substrate-facing surface of the body 5.

A plurality of fixing holes 6 are provided which pass through the body 5 The position of the fixing holes 6 corresponds to the position of fixing holes 7 in the LED modules 2.

The LED modules 2 are secured to the body 5 by pins 8 which pass through the fixing holes 7 within the LED module 2 and through the fixing holes 6 in the body 5. The pins 8 comprise a head 9 and a stem 10. The head 9 engages with a conductive surface 11 on the LED module 2 and the stem 10 is connectable to a power supply (not shown) for providing power to the conductive surface 11 via the head 9.

The head 9 of each pin 8 includes a recess 12 which accommodates a neck portion 13 of a tubular electrical insulating sleeve 14 positioned around the stem 10. The electrical insulating sleeve 14 prevents contact, and so conduction, between the stem 10 of the pin 8 and the LED module 2 and the body 5.

A compression spring 15 provides a biasing element for biasing the head 9 of each pin 8 towards the conductive surface 11 of the LED module 2, so that when the pin 8 is secured in place by a retaining clip 16 (e.g., a securing element) the head 9 is pressed against the conductive surface 11 of the LED module 2, as shown in FIGS. 1 and 2. In the embodiment shown in FIG. 1, in use the head 9 is forced upwards under the action of the biasing element 15, into contact with the conductive surface 11 of the LED module. It is understood that “upwards” refers to the orientation of the LED array in use, where a substrate to be cured is placed beneath the LED modules.

The retaining clip 16 allows for easy removal or securing of the pins 8 and thus the LED modules 2 during manufacture and in the event of LED module replacement or repair.

With reference to FIG. 2, pairs 17 of fixing pins 8 are provided for each LED module 2.

As shown in FIG. 3B, the fixing holes of each pair are provided in an offset configuration. In this respect, as shown with reference to the position of the heads 9 in each pair, a first head 9A is positioned half-way (centrally) along the edge of the LED module 2 and a second head 9B is positioned off-centre with respect to the opposite edge of the LED module 2. This ensures that the LED module 2 can only be installed in the orientation shown.

As shown in FIG. 3, the array 1 comprises a plurality of LED modules 2 placed side-by-side.

Each LED module 2 includes a plurality of LEDs 3 grouped across a central portion of the LED module 2 such that when a plurality of LED modules 2 are placed side-by-side, a continuous line of LEDs 3 is provided across the LED modules 2 and the length of the array 1.

The body 5 acts as a heat sink for heat generated by the LEDs 3 and includes a cooling element in the form of a flow and return channel 20. The channel 20 is substantially U-shaped with its entrance 21 and exit 22 positioned adjacent to each other at one end of the body 5. The longer lengths of the U-shaped channel 20 run along the length of the array 1. As cold water passes along the channel 20 from the entrance 21 it is gradually heated and carries away heat generated by the LEDs 3 to the exit 22, so that the body 5 is evenly cooled. In an alternative embodiment of the present invention, the cooling channel 20 comprises co-axial channels. It will also be appreciated that the body 5 could be air-cooled.

As shown in FIG. 4, the compression spring 15 is provided around an insulating sleeve around the stem 10, which prevents the spring becoming electrically conductive i.e. “live”. The pin 8 is housed within an annular electrical insulator 23. The annular electrical insulator 23 is accommodated within a recess 32 in the body 5. The end of the pin 8 distal from the head 9 passes through the annular electrical insulator 23 and is left exposed beyond the rim of the electrical insulator 23 to provide for connection of the pin 8 to an electrical connector of a power supply.

Referring to FIG. 1, the array 1 includes a cover or base-member provided by two opposing, co-planar plates 24, 25, which are each substantially co-planar with the head 9 of each pin 8. Each plate 24, 25 overlaps one of the two opposing end of the LED modules 2 with a curing aperture 26 formed therebetween. Light emitted from the LEDs can exit through this curing aperture 26. A quartz window 27 is slideably mounted across the curing aperture 26 between the plates 24, 25, positioned in use between the LED modules 2 and the substrate (not shown). The quartz window 27 is held within recesses 28 in the opposing edges of the plates 24, 25.

The plates 24, 25 pass over the head 9 of each pin 8. The head 9 of each pin 8 is electrically insulated from the adjacent plate 24, 25 by a layer of insulating material 29. The head 9 of each of the pins 8 are accommodated within recesses 30 on the LED module-facing surface of the plates 24, 25.

A heat conducting material (not shown) is provided between the LED modules 2 and the body 5. A heat conducting material is also provided between the LED modules 2 and the plates 24, 25. The heat conducting material can be any thermal transmitting compound. For example, a high performance interface material such as pyrolytic graphite sheet.

The array 1 is provided with an upper casing 31 enclosing the pairs of pins 17.

Referring to FIGS. 1 and 5, in a second embodiment of the present invention a pin 38 comprises a head 39 and a stem 40. The head 39 has substantially circular cross-section and a substantially planar upper face. The circular cross-section allows the pins to be mounted in different orientations through the fixing holes 6, 7 in the body 5 and LED modules 2. The substantially planar upper face of the pin head 39 ensures that proper electrical contact, between the pin head 39 and the conductive surface 11 on the LED module 2, is achieved. The second embodiment of the present invention allows for a compact pin-head design whilst maximising the surface area for electrical contact. Good electrical connection can be achieved whilst allowing multiple LED modules to be secured close together. By allowing the LED modules to be secured close together, the present invention allows for a greater number of LED modules to be mounted in the LED array.

In use, the upper surface of the head 39 engages with a conductive surface 11 of an LED module 2 and the stem 40 is connectable to a power supply for providing power to the conductive surface 11 via the head 39. The stem 40 of the pin 38 comprises a threaded section 42 and a tubular electrical insulating sleeve. The electrical insulating sleeve prevents electrical contact between the stem 40 of the pin 38 and the LED module 2 and the body 5.

A nut (not shown) is connectable to the threaded section 42 of the pin 38 and provides a securing element for securing the head 39 of the pin 38 in electrical contact with the conductive surface 11 of an LED module 2 so that, when the pin 38 is secured in place by the nut, the head 39 is forced upwardly and pressed against the conductive surface 11 of the LED module 2 to make electrical contact and power the LED array 1. It is understood that “upwards” refers to the orientation of the LED array in use, where a substrate to be cured is placed beneath the LED modules. Tightening of the bolt to the stem 40 is pre-configured to ensure that, when the bolt is threaded onto the stem 40, the head 39 of the pin 38 will be positioned in contact with the conductive surface 11.

The pins 38 of the present invention are made of brass to provide good electrical conduction and are nickel-plated to stop oxidisation of the pins.

In use, the above-described apparatus allows the LED modules 2 to be positioned as close as possible to the substrate (not shown). For example, in preferred embodiments of the present invention, when the substrate passes the quartz window 27, the LED modules 2 are positioned between about 2 mm and about 4 mm typically from the substrate.

In use, an ink curing apparatus including the array 1 of the present invention makes use of a “kissing roller”. A “kissing roller” allows the substrate to be transported in close proximity to the LED modules 2 and, in turn, the LEDs mounted on the LED modules, without any wrinkling of the web upon which the substrate is placed.

The above described embodiment has been given by way of example only, and the skilled reader will naturally appreciate that many variations could be made thereto without departing from the scope of the claims.

1. An LED array for UV print curing comprising one or more LED modules, the array comprising
a body which comprises a mounting area comprising one or more LED modules mounted thereon, and
two or more fixing holes through the body, said fixing holes having a position corresponding to a position of fixing holes in the one or more LED modules mounted on the mounting area,
wherein the one or more LED modules are secured to the body by pins which pass through the fixing holes within the LED module and through the fixing holes in the body, said pins comprising a head and a stem, wherein the head engages with a conductive surface on the LED module and the stem is connectable to a power supply for providing power to the conductive surface of the LED module via the head.

2. An LED array according to claim 1 comprising a plurality of securing elements for securing each pin such that the head of each pin is in contact with the conductive surface of the or each LED module.

3. An LED array according to claim 2 wherein each of the plurality of securing elements comprises a nut rotatable about a screw thread provided on the stem of each pin.

4. An LED array according to claim 1 wherein each pin comprises a biasing element biasing the head of each pin towards the conductive surface of the LED module when the pin is secured in place by a securing element.

5. An LED array according to claim 1 wherein the pin head comprises a circular cross-section.

6. An LED array according to claim 1 wherein each pin is made of nickel-plated brass.

7. An LED array according to claim 1 wherein the end of each pin that is distal from the pin head is shaped for engagement with an electrical connector of a power supply.

8. An LED array according to claim 1 wherein a pair of fixing holes is provided for each LED module, and wherein the fixing holes of each LED module are provided in an offset configuration.

9. An LED array according to claim 1, wherein the array comprises electrically insulating elements preventing electrical contact between the stem of each pin and the LED module, and wherein the electrically insulating elements include a sleeve positioned around the stem of the pin.

10. An LED array according to claim 9, wherein the electrically insulating elements extend around the neck of each of the pins.

11. An LED array according to claim 1, wherein the head of each pin comprises a recess for accommodating a neck portion of an electrical insulating sleeve positioned around the stem of the pin.

12. An LED array according to claim 1, comprising a cooling channel formed within the body through which a fluid can pass.

13. An LED array according to claim 4, wherein at least one biasing element is selected from a spring; a deformable gasket; and a belleville washer.

14. An LED array according to claim 2, wherein each securing element comprises a retaining clip.

15. An LED array according to claim 4, wherein each biasing element is housed within an electrical insulator.

16. An LED array according to claim 1 comprising a cover including an aperture through which light generated by the LEDs can pass.

17. An LED array according to claim 16, wherein the cover comprises two cover parts, each part positioned over opposing ends of the LED modules, with a gap formed therebetween, and a transparent window for the aperture.

18. An LED array according to claim 17, wherein the transparent window is removable.

19. An LED array according to claim 18, wherein opposing edges of the cover which define the aperture comprise recesses for slideably accommodating the transparent window.

20. An LED array according to claim 16, wherein the cover passes over the head of each pin.

21. An LED array according to claim 16, wherein the head of each pin is electrically insulated from the cover.

22. An LED array according to claim 16, wherein the head of each pin is accommodated within a respective recess on a module facing surface of the cover.

23. An LED array according to claim 1, wherein a heat conducting material is provided between the one or more LED modules and the body.

24. An LED array according to claim 16, wherein a heat conducting material is provided between the one or more LED modules and the cover.

25. A UV ink curing apparatus comprising one or more LED arrays according to claim 1.

26. A UV ink curing apparatus according to claim 25, further comprising a kissing roller.
